(19) United States
(12) Patent Application Publication
(10) Pub. No.: US 2021/0340360 A1
(43) Pub. Date: Nov. 4, 2021

(54) Rubber Composition with Surface Modified Carbon Black and Functionalized Process Oil

(71) Applicant: BIRLA CARBON U.S.A., INC., MARIETTA, GA (US)

(72) Inventors: CHARLES R HERD, MARIETTA, GA (US); ZACHARY A COMBS, MARIETTA, GA (US); CRISTINA BERGMANN, HAMBURG (DE); JURGEN TRIMBACH, HAMBURG (DE)

(21) Appl. No.: 17/282,054

(22) PCT Filed: Aug. 5, 2019
(86) PCT No.: PCT/US2019/045124

§ 371 Date: Apr. 1, 2021

Related U.S. Application Data
(60) Provisional application No. 62/714,184, filed on Aug. 3, 2018.

(51) Int. Cl. C08L 15/00; C08L 7/00; B60C 1/00

(52) U.S. Cl. CPC C08L 15/00; C08L 2205/03; B60C 1/0016; C08L 7/00

(57) ABSTRACT

Rubber composition with surface-modified carbon black and functionalized process oil.

### BACKGROUND

### Technical Field

The present disclosure relates to: carbon black compositions comprising a surface modified carbon black; biorenewable functionalized process oils; elastomeric compositions comprising the same; and to methods for the manufacture and use of both the carbon black compositions and elastomeric compositions.

### Technical Background

Carbon black is frequently used as a reinforcing filler in elastomeric systems. When these elastomeric compositions, such as a rubber compound, are mixed, process oils are often required and are typically aromatic-type oils. To improve interaction between the carbon black and the elastomer, efforts have been undertaken to combine carbon blacks with functionalized elastomer compositions. While the use of such functionalized elastomer compositions can provide improved properties and performance, the cost of such materials can be prohibitive.

Thus, there is a need for improved carbon black materials and elastomeric compositions comprising the same. These needs and other needs are satisfied by the compositions and methods of the present disclosure.

### SUMMARY

In accordance with the purpose(s) of the invention, as embodied and broadly described herein, this disclosure, in one aspect, relates to carbon black and elastomeric materials, together with methods for the manufacture and use thereof.

In one aspect, the present disclosure provides an elastomer compound composition comprising a carbon black and biorenewable process oil.

In another aspect, the present disclosure provides an elastomer compound composition comprising a functionalized carbon black and functionalized process oil.

In another aspect, the present disclosure provides an elastomer compound composition comprising a carbon black functionalized with hydroxyl and/or carboxylic acid groups.

In another aspect, the present disclosure provides an elastomer compound composition comprising a functionalized process oil described as a fatty-acid ester.

In another aspect, the present disclosure provides an elastomer compound composition comprising a functionalized process oil described as an epoxidized fatty-acid ester.

In yet another aspect, the present disclosure provides methods for preparing elastomer compositions comprising a functionalized carbon black and functionalized process oil.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying figures, which are incorporated in and constitute a part of this specification, illustrate several aspects and together with the description serve to explain the principles of the invention.

FIG. 1 illustrates the schematic property improvement resulting from functionalized process oil and surface-modified carbon black, in accordance with various aspects of the present disclosure.

FIG. 2 illustrates the tangent delta at 60° C. for NR/ENR (natural rubber/epoxidized natural rubber) compounds containing surface modified carbon black (SM-CB), the functionalized process oils, FAEE (fatty acid ester epoxidized) and FAE (fatty acid ester), in accordance with various aspects of the present disclosure.

FIG. 3 illustrates the Vieth tear strength for NR/ENR compounds containing SM-CB the functionalized process oils, FAEE and FAE, in accordance with various aspects of the present disclosure.

FIG. 4 illustrates the die C tear strength versus tangent delta at 60° C. for NR/ENR compounds containing SM-CB the functionalized process oils, FAEE and FAE, compared to silica, in accordance with various aspects of the present disclosure.

FIG. 5 illustrates the modulus build for NR/ENR compounds containing SM-CB the functionalized process oils, FAEE and FAE, in accordance with various aspects of the present disclosure.

FIG. 6 illustrates the tensile strength for NR/ENR compounds containing SM-CB the functionalized process oils, FAEE and FAE, in accordance with various aspects of the present disclosure.

FIG. 7 illustrates the characteristic fatigue life for NR/ENR compounds containing SM-CB the functionalized process oils, FAEE and FAE, in accordance with various aspects of the present disclosure.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used herein, unless specifically stated to the contrary, the singular forms “a,” “an” and “the” include plural referents unless the context clearly dictates otherwise. Thus, for example, reference to “a filler” or “a solvent” includes mixtures of two or more fillers, or solvents, respectively.

As used herein, unless specifically stated to the contrary, the abbreviation “phr” is intended to refer to parts per hundred, as is typically used in the plastics industry to describe the relative amount of each ingredient in a composition.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

Unless indicated otherwise, parts are parts by weight, temperature is in ° C. or is at ambient temperature, and pressure is at or near atmospheric. References to carbon black materials starting with “N”, such as, for example, N234, are intended to refer to standard ASTM grade carbon blacks (see, for example, ASTM D-1765). References to SM-CB are intended to refer to the inventive functionalized carbon black described herein. References to FAE (fatty acid ester) and FAEE (fatty acid ester epoxidized) are intended to refer to the inventive functionalized process oils described herein. References to epoxy are intended to include hydrocarbon materials, such as, for example, oils, having at least one epoxide functionality.

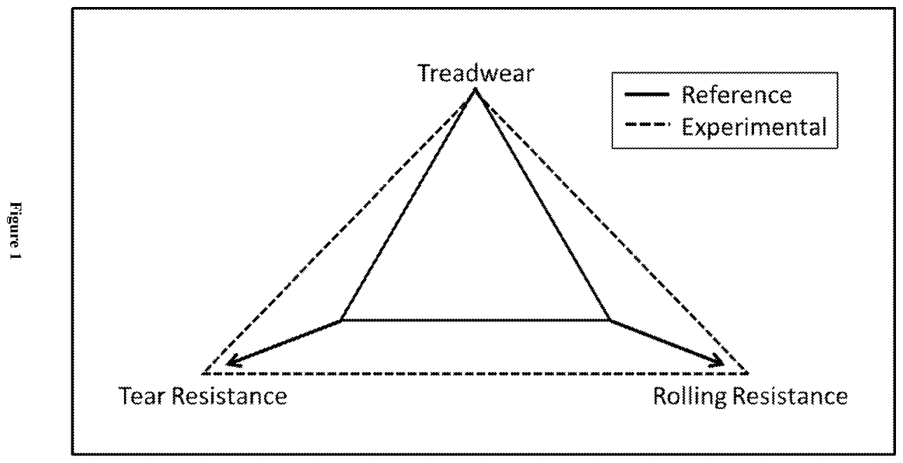

As briefly described above, the present disclosure provides, in some aspects, elastomer compound compositions comprising a functionalized carbon black together with a functionalized process oil, and methods for manufacturing and using the elastomeric compositions. Prior efforts to improve the interaction between carbon black and elastomeric materials have employed functionalized elastomers, which can interact with functional groups on the carbon black surface. This interaction can often be very strong and can result in a detrimental impact to several important compound properties. The triangle of conventional rubber properties is illustrated in FIG. 1, wherein an improvement in one or two properties typically results in a deterioration in the remaining properties. In one aspect, the inventive approach described herein comprises the use of a functionalized carbon black and functionalized process oil, wherein the resulting elastomer composition exhibits the performance benefits that can be attributed to good filler-elastomer interaction, while maintaining other desirable properties. In various aspects, the resulting elastomeric compositions can provide reduced rolling resistance, improved modulus, and improved tear resistance, as compared to conventional carbon black elastomer compositions and their functionalized countertypes, which may show reduced rolling resistance, improved modulus, but with deficient tear resistance.

The carbon black of the present invention can comprise any carbon black suitable for use with the process oil and/or elastomeric materials employed. In one aspect, the carbon black is a furnace carbon black.

In various aspect, the carbon black can have a nitrogen surface area, as determined by, for example, ASTM Method D6556-14, of from about 90 m²/g to about 140 m²/g; from about 95 m²/g to about 135 m²/g; from about 100 m²/g to about 130 m²/g; from about 105 m²/g to about 125 m²/g; from about 110 m²/g to about 125 m²/g; from about 115 m²/g to about 125 m²/g; from about 110 m²/g to about 120 m²/g; from about 115 m²/g to about 120 m²/g; from about 115 m²/g to about 121 m²/g; or from about 116 m²/g to about 120 m²/g. In another aspect, the carbon black can have a nitrogen surface area of about 90, 92, 94, 96, 98, 100, 102, 104, 106, 108, 110, 112, 114, 116, 118, 120, 122, 124, 126, 128, 130, 132, 134, 136, 138, or 140 m²/g. In yet another aspect, the carbon black can have a nitrogen surface area of about 118 m²/g. In other aspects, the carbon black of the present invention can have a nitrogen surface area greater than or less than any value specifically recited herein, and the present invention is not intended to be limited to any particular nitrogen surface area value.

In another aspect, the carbon black can have an external surface area, based on the statistical thickness method (STSA, ASTM D6556-14), of from about 80 m²/g to about 125 m²/g; from about 85 m²/g to about 120 m²/g; from about 90 m²/g to about 115 m²/g; from about 95 m²/g to about 110 m²/g; from about 95 m²/g to about 105 m²/g; from about 98 m²/g to about 104 m²/g; or from about 99 m²/g to about 103 m²/g. In another aspect, the carbon black can have an external surface area of about 101 m²/g. In various aspects, the external surface area of a carbon black is the specific surface area that is accessible to a rubber compound. In other aspects, the carbon black of the present invention can have an external surface area greater than or less than any value specifically recited herein, and the present invention is not intended to be limited to any particular external surface area value.

The carbon black of the present invention can have a pH, as measured by, for example, ASTM Method D1512-15 using either Test Method A or Test Method B, of from about 2.5 to about 4; from about 2.8 to about 3.6; or from about 3 to about 3.4. In another aspect, the carbon black of the present invention can have a pH of about 3.2. In other aspects, the carbon black of the present invention can have a pH greater than or less than any value specifically recited herein, and the present invention is not intended to be limited to any particular pH value.

The carbon black of the present invention can have a void volume, as determined by, for example, ASTM Method D6086-09a, of from about 55 cm³/100 g to about 67 cm³/100 g (50 GM); from about 60 cm³/100 g to about 65 cm³/100 g (50 GM); from about 50 cm³/100 g to about 60 cm³/100 g (75 GM); from about 53 cm³/100 g to about 58 cm³/100 g (75 GM); from about 45 cm³/100 g to about 55 cm³/100 g (100 GM); or from about 47 cm³/100 g to about 53 cm³/100 g (100 GM). In another aspect, the carbon black can have a 50 GM void volume of about 62.2 cm³/100 g; a 75 GM void volume of about 55.3 cm³/100 g; and/or a 100 GM void volume of about 50.4 cm³/100 g. In other aspects, the void volume of a carbon black can be greater than or less than any value specifically recited herein, and the present invention is not intended to be limited to any particular void volume.

The carbon black of the present invention can have a moisture content, as measured by, for example, ASTM Method D1509-15, of from about 2.5 wt % to about 4.5 wt. %; from about 3 wt. % to about 4 wt. %; or from about 3.2 wt. % to about 3.8 wt. %. In another aspect, the carbon black of the present invention can have a moisture content of about 3.5 wt. %. It should be understood that the moisture content of carbon black materials can change, depending upon, for example, environmental and/or storage conditions, and as such, the particular moisture content of a given sample of carbon black can vary. In other aspects, the carbon black of the present invention can have a moisture content greater than or less than any value specifically recited herein, and the present invention is not intended to be limited to any particular moisture content value.

In one aspect, the carbon black of the present invention is an oxidized carbon black, such as, an oxidized furnace carbon black. Various methods exist to oxidize carbon blacks, such as, for example, ozonation, and the particular method for oxidizing a carbon black can vary, provided that a plurality of desired oxygen containing functional groups are present on the surface of the carbon black. In one aspect, the carbon black can be oxidized by treatment with ozone. In other aspects, the carbon black can be oxidized by other methods, such as, for example, acid or hydrogen peroxide.

In one aspect, the carbon black can be surface modified by, for example, any of the methods described in US Patent Publication No. 20130046064. In various aspects, the carbon black can be modified so as to have an increased amount of volatile content and/or oxygen on its surface. In one aspect, the carbon black can be oxidized. In another aspect, the carbon black can be amine treated. Various exemplary embodiments of surface treated carbon black are described below.

In one exemplary embodiment, ozonated samples of carbon black included Sturdivant-milled beaded-carbon-black treated in a rotating drum for various lengths of time, ranging from 1.5 to 5.5 hours, with an air flow containing approximately 2% ozone concentration followed by wet beading and then drying the samples in an oven at 125° C. for six hours. In another exemplary embodiment, hydrogen peroxide treated carbon black samples included powder carbon black wet beaded with a 50/50 weight percent of 35% to 50% hydrogen peroxide in a pin beader. The resulting wet beads were then dried in a fluid bed drier at 125° C. for two hours. In another exemplary embodiment, amine samples of carbon black were prepared by treating fifty grams of ozonated N234 powder added to 2.5 liters of water and 25 ml of acetone in a 6 liter Lab Max reaction vessel. Ethylene diamine, diluted to a 1% solution in distilled water, was slowly added to the Lab Max with constant stirring until the target pH was reached. The carbon black was separated from the water by pressure filtration and soxhlet extracted with distilled water for 16 hours. The carbon black sample was then coffee milled, wet beaded, and dried in an oven for six hours at 125° C.

The carbon black of the present invention can have a volatile content of from about 4.5 wt. % to about 6.5 wt. %; from about 5 wt. % to about 6 wt. %; or from about 5.2 wt. % to about 5.8 wt. %. In another aspect, the carbon black of the present invention can have a volatile content of at least about 4.5 wt. %, at least about 5 wt. %, at least about 5.5 wt. %, or higher. In another aspect, the carbon black of the present invention can have a volatile content of about 5.5 wt. %. In still other aspects, the volatile content of a carbon black can be greater than or less than any value specifically recited herein, and the present invention is not intended to be limited to any particular volatile content value. In one aspect, volatile content can be measured by filling a self sealing, quartz crucible of known weight with carbon black, and placing in an oven at 125° C. with the lid off for 1 hour. The crucible can then be removed and placed in a dessicator while cooling to room temperature. The cooled and dried crucible can then be weighed, after which, the crucible can be placed in a muffle furnace at 950° C. for 15 minutes. The crucible can then be removed and cooled again in a dessicator. For low density and/or powdered carbon black samples, the carbon black sample can be compressed prior to heating. The volatile content is defined as the weight of the heated (i.e., devolatilized) carbon black divided by the weight of the dried (i.e., at 125° C.) carbon black, multiplied by 100.

The carbon black of the present invention can have an oxygen content of from about 2.5 wt. % to about 5.5 wt. %; from about 3 wt. % to about 5 wt. %; from about 3.5 wt. % to about 4.5 wt. %; or from about 3.7 wt. % to about 4.3 wt. %. In another aspect, the carbon black of the present invention can have an oxygen of at least about 3.5 wt. %, at least about 4 wt. %, or higher. In another aspect, the carbon black of the present invention can have an oxygen content of about 4 wt. %. In still other aspects, the oxygen content of a carbon black can be greater than or less than any value specifically recited herein, and the present invention is not intended to be limited to any particular oxygen content value. In one aspect, oxygen content can be determined using an EMGA-820 Oxygen/Nitrogen analyzer, available from Horiba Scientific, Edison, N.J., USA. This technique utilizes an impulse furnace, which applies electric current through a graphite crucible to rapidly heat the crucible and carbon black sample. The carbon black sample undergoes thermal decomposition and the resulting gases are analyzed by a non-dispersive infrared detector and a thermal conductivity detector. A glass scintillation vial can be partially filled with carbon black and dried in a vacuum oven overnight at 120° C. 30 mg of the dried carbon black can then be placed in a nickel capsule and pressed to close. The closed capsule is then analyzed to determine oxygen content.

The carbon black loading in the compounds of the present invention can be from about 20 phr to 80 phr, from about 30 phr to 70 phr, and from about 40 phr to 60 phr. In another aspect, the carbon black loading can be from about 45 phr to 55 phr. In another aspect, the carbon black loading can be about 52 phr. In still other aspects, the carbon black loading in the present invention is not intended to be limited to any particular loading.

The process oil of the present invention can comprise any process oil capable of interacting with the carbon black and providing one or more of the desired performance improvements when compounded with an elastomer.

Conventional process oils used in rubber compounding typically contain high levels of aromaticity like distilled aromatic extracts (DAE) and are used as viscosity modifiers to ease the mixing and processing of the rubber compound. Due to the strict requirements of Directive EC 769/76/EEC as well as 67/548/EC (passed by the European Commission), such plasticizers like DAE, can, in some aspects, be replaced with plasticizer compositions used in a formulation for a tire.

Alternatives to DAE are oils not classified according to CLP Regulation 1272/2008, e.g. MES (mild extracted solvate), RAE (residual aromatic extract), TRAE (treated residual aromatic extract), (H)NAP ((heavy) naphthenic oil), and treated distilled aromatic extract (TDAE). In various aspects, the oils can comprise less polycyclic aromatic hydrocarbons (PAH) than DAE and comply with the REACH Annex XVII Entry 50 (1-4). In the last years extensive research was done on the manufacturing of polymers with higher polarity in order to improve the interaction between polymers of a polymer matrix and fillers usually present in a polymer matrix and, as a result, the final properties of the polymer materials.

The primary object of the present invention is achieved by a composition for use as a plasticizer composition in a formulation for a tire wherein the composition comprises as ingredients, one or more fatty acid alkyl esters and/or fatty acid aryl esters, or one or more fatty acid alkyl esters epoxides and/or fatty acid aryl esters epoxides, or combinations thereof.

In contrast to conventional process oils and rubber mix compositions, the process oil of the present invention can comprise functionality that can impart a better filler-elastomer interaction in combination with a functionalized carbon black. In one aspect, the process oil of the present disclosure can interact with one or more functional groups on the surface of the carbon black.

In other aspects, the process oil can be described as a biorenewable material.

In one aspect, the process oil comprises a fatty acid ester chemistry. In another aspect, the process oil comprises an epoxidized fatty acid ester chemistry. In yet another aspect, the process oil possesses the appropriate chemical and physical properties to act as a typical extender oil in a rubber compound.

In one aspect, the process oil comprises functional groups that can interact with both the carbon black surface groups and the elastomer matrix. In various aspects, electronegative groups, such as, for example, epoxy groups, can interact with functional groups on the carbon black surface. In one aspect, the process oil comprises at least one electronegative group. In another aspect, the process oil comprises at least two electronegative groups of the same or differing type. In another aspect, at least one electronegative group comprises an epoxy or ester group.

In one aspect, one or more esters comprise a fatty acid alkyl ester and/or a fatty acid aryl ester compound of formula (I)

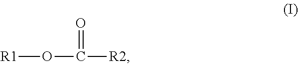

wherein R1 is a substituted or unsubstituted aryl radical having a total number of 22 carbon atoms or less, in some aspects having a total number of 10 carbon atoms or less, and in other aspects comprising substituted and unsubstituted phenyl, or a substituted or unsubstituted, branched or linear, alkyl radical having a total number of 22 carbon atoms or less, or comprising ethyl, propyl, butyl, pentyl, hexyl, heptyl, octyl, and benzyl, or in other aspects, 2-ethyl-hexyl, and R2 is a substituted or unsubstituted, branched or linear, saturated or unsaturated aliphatic hydrocarbon radical having a total number of 21 carbon atoms or less, in some aspects a linear, saturated or unsaturated aliphatic hydrocarbon radical having 21 carbon atoms or less, and in other aspects a linear, unsaturated aliphatic hydrocarbon radical having 21 carbon atoms or less and one, two or three double bonds, wherein R2 can, in some aspects, comprise a linear, unsaturated aliphatic hydrocarbon radical having 17 carbon atoms or less and one double bond.

In various aspects, a composition can comprise one or more fatty acid alkyl esters, such as, for example, alkyl arachidonate, alkyl linoleate, alkyl linolenate, alkyl laurate, alkyl myristate, alkyl oleate, alkyl caprate, alkyl oleate, alkyl stearate, alkyl palmitate, alkyl caprylate alkyl caproate, alkyl butyrate, or alkyl behenate. In other aspects, the one or more fatty acid alkyl esters can comprise 2-ethylhexyl oleate.

In other aspects, the process oil can comprise one or more epoxide, such as, for example, fatty acid alkyl ester epoxide and/or fatty acid aryl ester epoxide, such as a compound of formula (II)

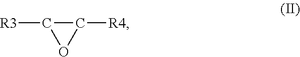

wherein R3 is a substituted or unsubstituted aryl radical having a total number of 22 carbon atoms or less, in some aspects having a total number of 10 carbon atoms or less, and in other aspects comprising substituted and unsubstituted phenyl, or a substituted or unsubstituted, branched or linear, alkyl radical having a total number of 22 carbon atoms or less, or comprising ethyl, propyl, butyl, pentyl, hexyl, heptyl, octyl, and benzyl, or in other aspects 2-ethyl-hexyl, and R4 is a substituted or unsubstituted, branched or linear, saturated or unsaturated aliphatic hydrocarbon radical having a total number of 21 carbon atoms or less, in some aspects a linear, saturated or unsaturated aliphatic hydrocarbon radical having 21 carbon atoms or less, or in other aspects a linear, unsaturated aliphatic hydrocarbon radical having 21 carbon atoms or less and one, two or three double bonds, wherein R2 can, in some aspects, comprise a linear, unsaturated aliphatic hydrocarbon radical having 17 carbon atoms or less and one double bond.

In various aspects, a composition can comprise one or more fatty acid alkyl ester epoxide, such as, for example, alkyl arachidonate, alkyl linoleate, alkyl linolenate, alkyl laurate, alkyl myristate, alkyl oleate, alkyl caprate, alkyl oleate, alkyl stearate, alkyl palmitate, alkyl caprylate alkyl caproate, alkyl butyrate, or alkyl behenate. In other aspects, the one or more fatty acid alkyl ester epoxides can comprise 2-ethylhexyl oleate.

While not wishing to be bound by theory, it is believed that the epoxy and/or ester moieties of the process can interact with oxygen containing functional groups, such as, for example, hydroxyl and/or carboxylic acids, on the carbon black surface through hydrogen bonding or a covalent reaction. In such a reaction, the process oil can act as a compatibilizing agent between the carbon black and an elastomer during a subsequent processing and/or compounding step.

It is also believed that the epoxy and/or ester moieties of the process can interact with oxygen containing functional groups, such as, for example, hydroxyl, carboxylic acid, and/or epoxy groups, that can be found in epoxidized natural rubber or other functionalized elastomers. In such a reaction, the process oil can act as a compatibilizing agent between the carbon black and an elastomer during a subsequent processing and/or compounding step.

The process oil of the present invention can be utilized as a direct replacement for all or a portion of a conventional aromatic process oil in a typical rubber mix.

In another aspect, the process oil can comprise TP130B and/or TP130C, available from Hansen & Rosenthal KG, Hamburg, Germany. In another aspect, the process oil can comprise an oil seed derivate. In yet another aspect, the process oil can comprise an oil derived from sunflower seed.

The amount of process oil added to the rubber compound formulation can be any amount suitable for use with the carbon black and/or elastomer to provide one or more desired properties. In various aspects, the process oil can be present in an amount approximately equivalent to greater than 0 up to about 40 phr, on the basis of a compounded elastomer mixture. In other aspects, the process oil can be present in an amount from about 5 phr to about 25 phr, depending upon, for example, the specific elastomers and other components used, and the desired properties of the resulting compound. In still other aspects, the process oil can be present in an amount from about 10 phr to about 20 phr.

In various exemplary embodiments, the process oil can be TP130B or TP130C, present in an amount of about 4 phr in an optimized truck/bus radial (TBR) tread composition.

It should be noted that the functionalized carbon black and functionalized process oil combination, can be utilized in any conventional elastomer compound, such as styrene-butadiene rubber/butadiene rubber (SBR/BR) compositions for passenger treads, natural rubber/butadiene rubber (NR/BR), or epoxidized natural rubber/natural rubber/butadiene rubber (ENR/NR/BR) compositions for truck treads, as well as other conventional and functionalized elastomer compositions not specifically recited herein.

The inventive functionalized carbon black and functionalized process oil combination can impart one or more improved performance properties to a resulting elastomeric compound. In one aspect, use of the inventive compound composition can provide a significant reduction in rolling resistance over comparable conventional elastomer compounds. In various aspects, the tan delta of the compound of the present disclosure can be reduced by up to about 20%, 25%, 30%, 35%, 40%, 45%, 50% or more, as compared to conventional compounds. In yet another aspect, the tan delta of the compound in the present disclosure can be reduced by up to about 40%, as compared to conventional compounds, for example, comprising non-functionalized process oil, non-functionalized carbon black, and non-functionalized elastomer.

In other aspects, the inventive compound composition can provide a significant improvement in tear resistance over comparable conventional elastomer compounds. In various aspects, the tear resistance of the compound of the present disclosure can be improved by up to about 20%, 25%, 30%, 35%, 40%, 45%, 50%, 55%, 60%, or more, as comparted to conventional compounds. In another aspect, the tear resistance of the compound in the present disclosure can be improved by up to 50%, as compared to conventional compounds.

The observed combination of improved tear resistance and reduced tan delta is surprising given the tendency of these two properties to typically trend in opposite directions; particularly with silica in NR-containing TBR compounds.

In one aspect, a surface-modified carbon black with FAEE or FAE can provide reduced hysteresis with improved tear resistance, as compared to a conventional N234 carbon black.

In another aspect, a surface-modified carbon black with FAEE or FAE can provide good modulus build, improved tensile strength, and/or improved fatigue life, as compared to a conventional surface modified carbon black.

An exemplary rubber formulation for a typical TBR compound is listed below, in Table 1.

TABLE 1
Exemplary formulations for typical TBR
compounds and experimental compounds.

| | Reference | Experimental |
|---|---|---|
| Component | Compound | Compound |
| NR | 100 | 50 |
| ENR | — | 50 |
| N234 | 55 | 13.75 |
| SM-CB | — | 41.25 |
| TDAE | 5 | — |
| Experimental Process Oil | — | 5 |
| Ca Stearate | 1 | 1 |
| ZnO | 3 | 3 |
| Stearic Acid | 3 | 3 |
| 6PPD | 1 | 1 |
| TMQ | 1 | 1 |
| Sulfur | 1.8 | 1.8 |
| TBBS | 2.4 | 2.4 |
| DPG | — | 1.5 |

The formulation in Table 1 comprises a blend of NR and ENR elastomers, together with a blend of N234 carbon black and an ozonzated carbon black (SM-CB), as described herein. Other components are commercially available and known in the art. TDAE-Vivatec 500 is a process oil, available from Hansen & Rosenthal KG, Hamburg, Germany; 6PPD is N-(1,3-Dimethylbutyl)-N′-phenyl-p-phenylenediame antioxidant, available from Eastman Santoflex, USA; TMQ is 2,2,4-Trimethyl-1,2-Dihydroquinoline polymer antioxidant, available from Shandong Stair Chemical & Technology Co., Ltd., Shandong, China; TBBS is N-tert-Butyl-2-Benzothiazolesulfenamide cure accelerator, available from Linkwell Rubber Chemicals Company, Qingdao, China; and DPG is diphenyl guanidine accelerator, available from Akrochem Corporation, Akron, Ohio, USA.

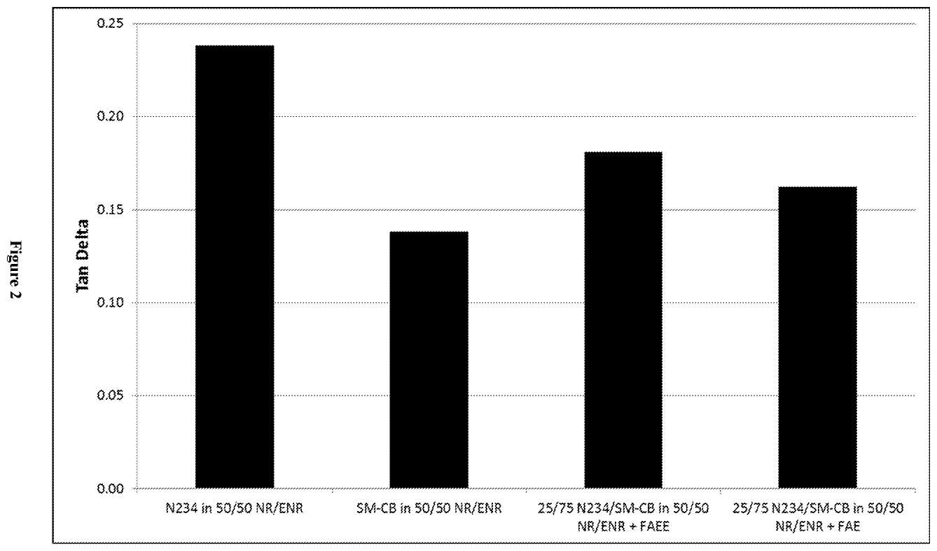

FIG. 2 illustrates the tangent delta at 60° C. for NR/ENR compounds containing SM-CB the functionalized process oils, FAEE and FAE, in accordance with various aspects of the present disclosure. In FIG. 2, the samples represent: (a) an unmodified N234 grade carbon black was mixed with a 50/50 blend of NR/ENR and conventional process oil; (b) a surface modified carbon black, as described herein, mixed with a 50/50 blend of NR/ENR and conventional process oil; (c) a 25/75 blend of unmodified N234 grade carbon black and surface modified carbon black, as described herein, mixed with a 50/50 blend of NR/ENR and FAEE; and (d) a 25/75 blend of unmodified N234 grade carbon black and surface modified carbon black, as described herein, mixed with a 50/50 blend of NR/ENR and FAE.

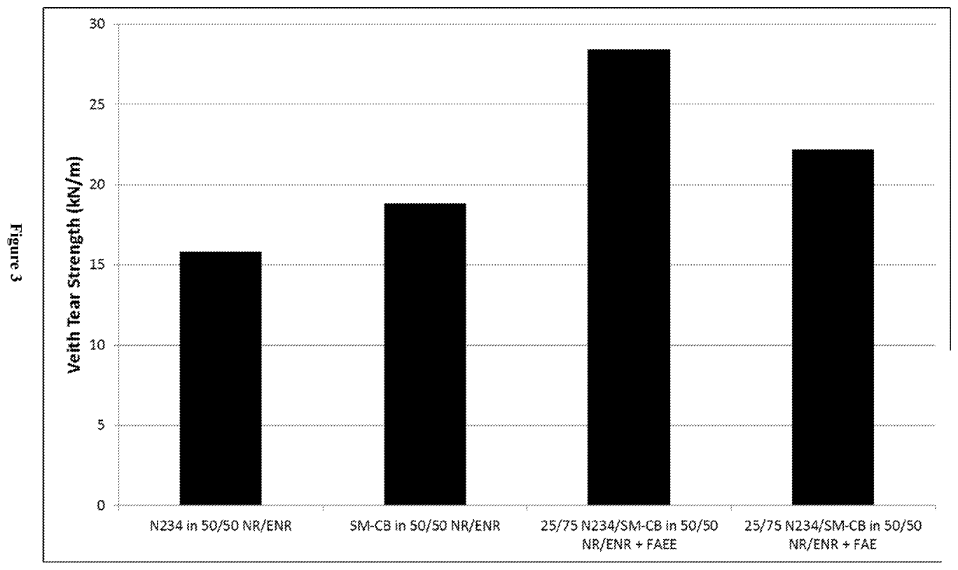

FIG. 3 illustrates the Vieth tear strength for NR/ENR compounds containing SM-CB the functionalized process oils FAEE and FAE, for the same samples identified in FIG. 2. The Veith tear strength is significantly increased for those samples using FAEE and FAE.

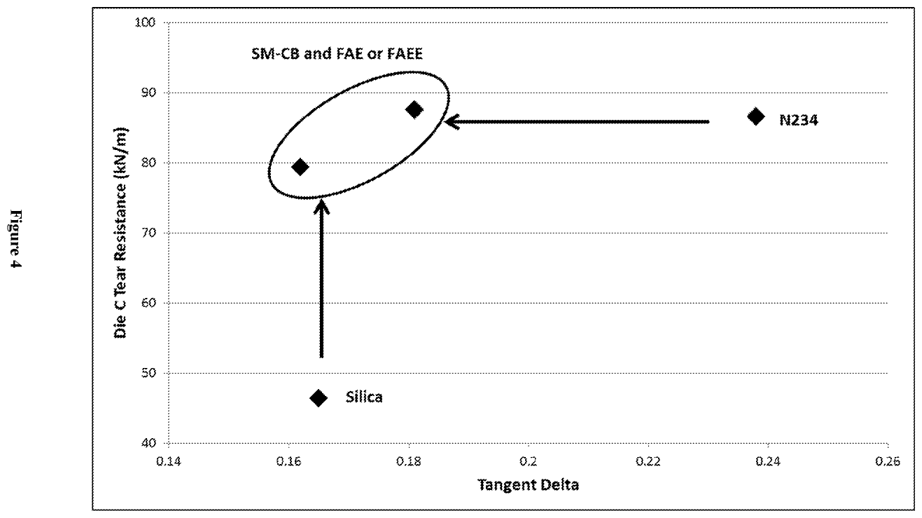

FIG. 4 illustrates the die C tear strength versus tangent delta at 60° C. for NR/ENR compounds containing SM-CB the functionalized process oils, FAEE and FAE, compared to conventional silica containing compounds. The use of the inventive materials results in a significant reduction in tan delta and improvement in Die C tear strength.

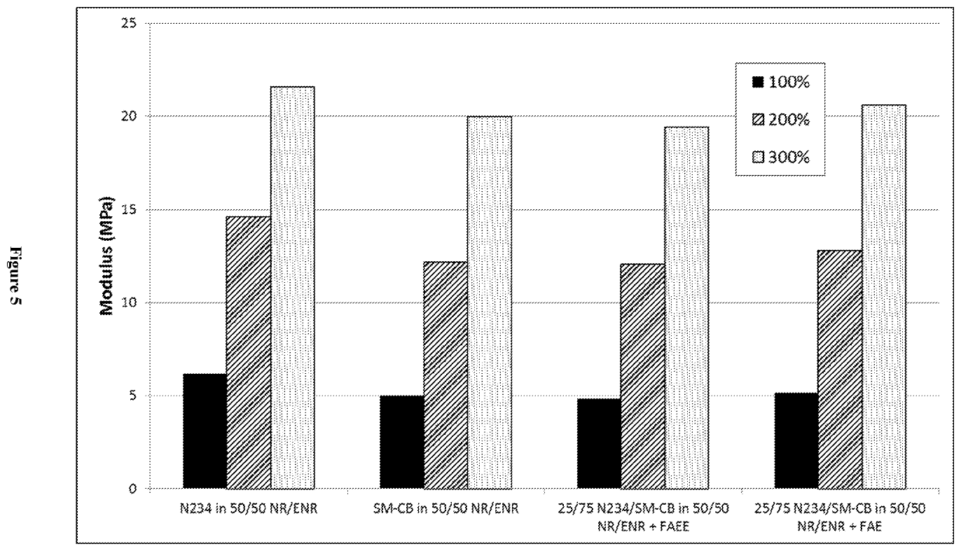

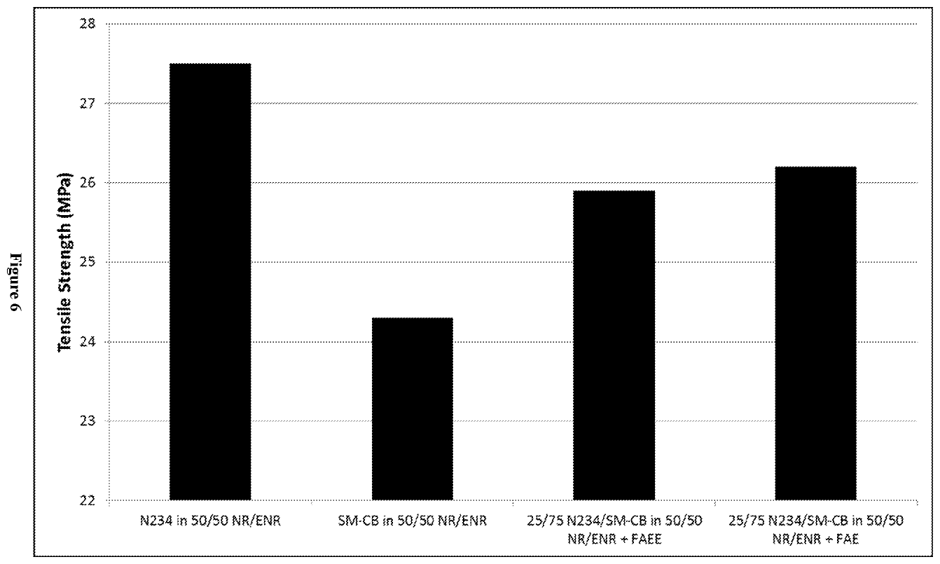

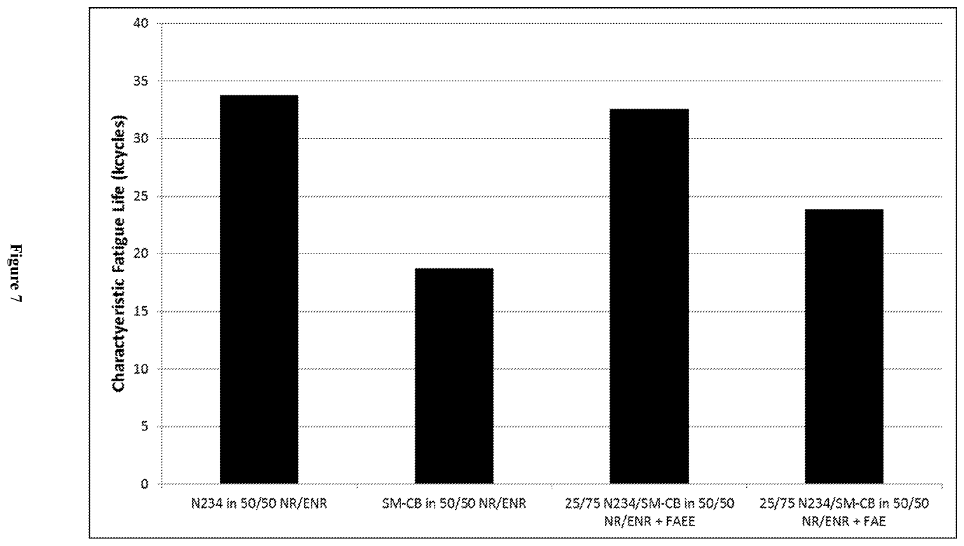

FIG. 5 illustrates the modulus build for NR/ENR compounds containing SM-CB the functionalized process oils, FAEE and FAE, for the samples described in FIG. 2. FIG. 6 illustrates the tensile strength for NR/ENR compounds containing SM-CB the functionalized process oils, FAEE and FAE, for the samples described in FIG. 2. FIG. 7 illustrates the characteristic fatigue life for NR/ENR compounds containing SM-CB the functionalized process oils, FAEE and FAE.

Thus, in one aspect, the invention composition can provide performance exceeding that of silica formulations. In addition, the resulting elastomeric compound can exhibit high modulus, tensile strength and improved fatigue life. In addition, the inventive composition can facilitate easy mixing, processing, and extrusion of the elastomer compounds. Such elastomer compounds comprising the inventive composition do not exhibit a reduction in tear strength that is typically seen when using functionalized fillers to achieve reduced rolling resistance.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A composition comprising an elastomer, a functionalized carbon black, and a process oil that is at least one of functionalized or biorenewable.

2. (canceled)

3. The composition of claim 1, wherein the process oil is functionalized and can be described as a fatty acid ester or an epoxidized fatty acid ester.

4. (canceled)

5. The composition of claim 1, wherein the process oil comprises an epoxide functionality.

6. The composition of claim 1, wherein the process oil comprises one or more fatty acid esters, fatty acid aryl esters, fatty acid alkyl ester epoxides, or fatty acid aryl ester epoxides, or a combination thereof.

7. The composition of claim 1, wherein the process oil is biorenewable.

8. (canceled)

9. The composition of claim 1, wherein the carbon black is oxidized.

10. The composition of claim 1, wherein the carbon black is ozonated.

11. The composition of claim 1, wherein the carbon black is functionalized with hydroxyl groups, carboxylic acid groups, or a combination thereof.

12. (canceled)

13. (canceled)

14. The composition of claim 1, wherein the elastomer is functionalized.

15. The composition of claim 1, wherein both the elastomer and the process oil comprise an epoxide functionality.

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. The composition of claim 1, wherein the process oil is capable of interacting with both surface groups present on the surface of the carbon black and with functional groups on the elastomer.

33. The composition of claim 1, wherein the process oil comprises one or more electronegative groups.

34. (canceled)

35. The composition of claim 33, wherein at least one of the electronegative groups comprises an epoxy or ester group.

36. A method comprising contacting an elastomer, a functionalized carbon black, and a process oil that is at least one of functionalized or biorenewable.

37. The method of claim 36, wherein the process oil can be described as a fatty acid ester and/or an epoxidized fatty acid ester.

38. The method of claim 36, wherein the process oil comprises an epoxide functionality.

39. (canceled)

40. (canceled)

41. (canceled)

42. The method of claim 36, wherein the elastomer is functionalized with the same or similar functionality as the process oil.

43. The method of claim 36, wherein the process oil replaces all or a portion of a conventional process oil.

44. A cured elastomer composition comprising the composition of claim 1.

45. A tire comprising the composition of claim 1.
